(19) United States
(12) Patent Application Publication
(10) Pub. No.: US 2026/0234944 A1
(43) Pub. Date: Aug. 13, 2026

(54) CELLULOSE BASED COMPOSITE PLANKS

(71) Applicant: Columbia Insurance Company, Omaha, NE (US)

(72) Inventors: Lawrence A. Strickland, Rome, GA (US); Michael J. Trapp, Dalton, GA (US); Donald Edward Hunt, JR., Ringgold, GA (US)

(21) Appl. No.: 19/637,460

(22) Filed: Apr. 2, 2026

Related U.S. Application Data
(63) Continuation of application No. 16/878,929, filed on May 20, 2020.
(60) Provisional application No. 62/850,160, filed on May 20, 2019.

(51) Int. Cl. E04F 15/10; B32B 7/10; B32B 23/04; B32B 23/18; B32B 23/20; B32B 37/00; B32B 37/10

(52) U.S. Cl. CPC E04F 15/107; B32B 7/10; B32B 23/04; B32B 23/18; B32B 23/20; B32B 37/1027; E04F 15/105; B32B 2037/0092; B32B 2264/10; B32B 2264/104; B32B 2317/18; B32B 2398/20; B32B 2451/00; B32B 2471/00

(57) ABSTRACT

Described herein are composite planks having a core layer and decorative layer. The composite planks contain layers are adhered to each other in absence of an adhesive material. Also described herein are methods for manufacturing composite planks. This abstract is intended as a scanning tool for purposes of searching in the particular art and is not intended to be limiting of the present invention.

### CROSS-REFERENCE TO RELATED APPLICATIONS

This Application is a continuation of U.S. Nonprovisional Application No. Ser. No. 16/878,929, filed May 20, 2020, which claims the benefit of U.S. Provisional Application No. 62/850,160, filed May 20, 2019. Each of the above-identified applications is incorporated herein by reference in its entirety.

### FIELD

In one aspect, the invention relates to composite floor planks comprised of cellulose material. More specifically, the invention relates to composite floor planks having cellulose material present in the core, a decorative layer, and a wear layer. Even more particularly, the invention relates to composite floor planks where all layers are laminated together without the use of adhesives. Also disclosed herein are the methods of making such planks.

### BACKGROUND

Conventional resilient floor coverings are typically produced in the form of a continuous sheet or in the form of a tile or a plank. Resilient flooring is typically formed as a composite laminated structure having a base layer, a decorative layer applied on top of the base layer, a protective film layer disposed on top of the decorative layer, and a top coat disposed on top of the protective film layer. For aesthetic purposes, the tile may also be mechanically embossed to impart a desired surface texture or pattern. To ensure stability of the flooring, various adhesive materials are used to adhere the layers to each other.

However, the conventional floorings that are formed from different materials require a large number of manufacturing steps that is costly. Furthermore, since more and more industries are adopting a “cradle-to-cradle” approach to manufacturing, a higher emphasis is put on recycling the final products and the possible incorporation of the recyclables into second-generation products. The conventional floorings that consist of various layers of different materials make the recycling process challenging, expensive, and inefficient.

There remains a need for resilient floor coverings exhibiting high flexural strength that contain a minimal amount (or substantially none) of adhesives and are formed by a direct lamination of the various layers with just the application of heat and pressure. Even further, there is a need for novel resilient floor coverings that comprise layers made of similar or substantially same materials and are easily recyclable in accordance with “cradle to cradle” design. Still further, there is a need for a method of making the same.

### SUMMARY

In accordance with the purpose(s) of the invention as embodied and broadly described herein, the invention, in one aspect, relates to composite planks having a core layer and a decorative layer comprised of a composition comprising a cellulosic material.

In an exemplary aspect, disclosed herein a composite plank comprising: a core layer having a top surface and an opposed bottom surface and a plurality of side edges extending between the opposed top and bottom surfaces, wherein the composite core layer is comprised of a filled polymeric composition comprising a thermoplastic cellulose ester component and a filler component; and a decorative layer comprised of a cellulose based material and having a top surface and an opposed bottom surface, wherein the decorative layer overlies the composite core layer such that the top surface of the core layer contacts the bottom surface of the decorative layer.

In another exemplary aspect, disclosed herein is a method for making a composite plank, comprising: a) forming a core layer from a composition comprising a thermoplastic cellulose ester component and a filler component; wherein the formed core layer has a top surface and an opposed bottom surface and a plurality of side edges extending between the opposed top and bottom surfaces, and b) applying a decorative layer comprised of a cellulose based material to the top surface of the core layer.

In another exemplary aspect, further disclosed herein is a method as summarized above wherein the decorative layer is applied to the top surface of the core layer by a lamination process.

In yet another exemplary aspect, further disclosed herein is a method as summarized above, wherein the lamination process does not comprise the application of an adhesive material.

Additional aspects of the invention will be set forth, in part, in the detailed description, and claims that follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE FIGURES

These and other features of the aspects of the invention described herein will become more apparent in the detailed description in which reference is made to the appended drawings wherein:

FIG. 1 depicts an exemplary structure of a composite plank according to aspects of the present invention.

FIG. 2 depicts an exemplary manufacturing methodology for producing a composite plank according to aspects of the present invention.

### DETAILED DESCRIPTION

The present invention can be understood more readily by reference to the following detailed description, examples, drawing, and claims, and their previous and following description. However, before the present articles, devices, systems, and/or methods are disclosed and described, it is to be understood that inventions described and claimed herein are not limited to the specific articles, devices, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps. Furthermore, it is to be understood that the terms comprise, comprising and comprises as they related to various aspects, elements and features of the disclosed invention also include the more limited aspects of “consisting essentially of” and “consisting of.”

As used throughout, the singular forms “a,” “an” and “the” include plural referents unless the context clearly dictates otherwise. Thus, for example, reference to “a layer” can include two or more such layers unless the context indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

As used herein, the term “substantially” means that the subsequently described event or circumstance completely occurs or that the subsequently described event or circumstance generally, typically, or approximately occurs. For example, when the specification discloses that substantially all of an agent is released, a person skilled in the relevant art would readily understand that the agent need not be completely released. Rather, this term conveys to a person skilled in the relevant art that the agent need only be released to an extent that an effective amount is no longer unreleased.

As used herein, the term “digital printing” refers to a digitally controlled ejection of drops of coloring fluid that is used to position colorants in pre-defined patterns onto a surface.

As used herein, the term “UV cured inks” refers to an ink that after application is at least partially cured by exposure to UV-light. For example, and without limitation, it is understood that UV cured inks can contain photo-initiators, additives, monomer, and oligomers. It is further understood that when these inks are exposed to a predetermined UV light power and/or intensity, polymerization of the polymers can occur by both a free radical and a cation curing.

### A. Composite Planks

In various aspects, the present invention relates to planks. In one aspect, the invention relates to a composite plank. In still further aspects, the invention relates to a composite plank configured for placement on a floor in a selected orientation. It is understood that the composite planks of the present invention are not limited for use in flooring applications. In certain aspects, the disclosed composite planks can be used as part of wall, ceiling, or furniture constructions. It is understood that the utility of the disclosed compose planks can be easily defined by one of ordinary skill in the art seeking planks having a minimal amount of adhesive materials and that are easily recyclable and exhibit high flexural strength.

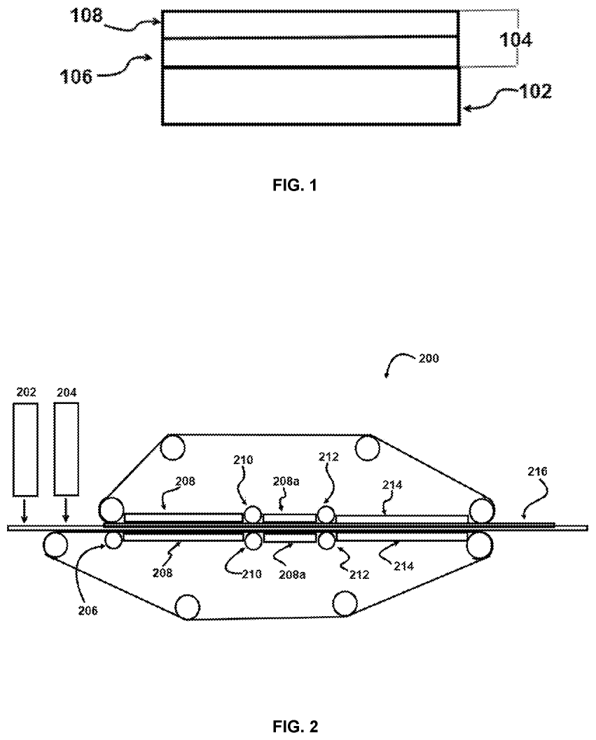

In a further aspect, and with reference to FIG. 1, the composite planks generally comprise a core layer (102) and a decorative layer (104). In certain aspects, the decorative layer (104) can comprise a printed film layer (106) and a wear layer (108).

In one aspect, the composite plank described herein can comprise a core layer having a top surface and an opposed bottom surface and a plurality of side edges extending between the opposed top and bottom surface. In still further aspects, the core layer can comprise a filled polymeric composition comprising a thermoplastic cellulose ester component and a filler component. In still further aspects, the plurality of edges can be profiled to form a locking connection between two adjacent composite planks. In certain aspects, the two adjacent composite planks are affixed in a manner that prevents relative lateral or horizontal separation between two panels.

In some aspects, a side edge locking structure can be an interlocking structure or mechanism as described herein. A conventional click lock mechanism is an example of a side edge locking structure. In contrast, it should be understood that conventional tongue and groove profiles that only restrict vertical movement of adjacent panels is not to be considered a side edge locking structure as the tongue and groove profile does not restrict lateral or horizontal displacement. It should therefore be understood that as used herein, aspects that specifically disclaim a side edge locking structure still include (do not exclude) aspects where, for example, the side edge simply abuts another side edge in view of having no special profile, and also include aspects having conventional tongue and groove profiles.

As used herein, the terms “interlocking mechanism” or “interlocking structure” refer to locking means, which lock adjacent composite planks together in manner that restricts or prevents at least a horizontal separation of two adjacent interlocked planks. This can also include aspects that prevent both a horizontal or lateral separation and relative vertical displacement. Some exemplary interlocking mechanisms contain both a tongue type protrusion and a groove like profile within the same composite plank, such as, for example, a click lock type profile. For example, the tongue type profile can be machined into one side and one end of the board with the groove-like profile being machined into the opposite side and end of the same plank. Such joints can be made by machining the edges of the planks. Alternatively, parts of the interlocking mechanism can be made of a separate material, which is then integrated into the composite plank. It is understood that the term “interlocking mechanism” is not construed to be limited to only profiles or feature that are integral to the floor covering planks. Other exemplary interlocking mechanisms include snapping connections incorporated into the plank edges, angling planks with interlocking edges, planks with overlapping edges, planks with the puzzle-lock edges, planks with slopping edges etc. It is understood that the term “interlocking mechanism” allows a plurality of planks to be readily joined in interlocking relationship such that when assembled, there is no necessity for separate structural frames.

In certain aspects, besides the locking means provided by the composite planks described herein, the interlocking mechanism, as defined herein, can further include locking elements. In some examples, such locking elements can include strips with salient features that engage the locking element onto two adjacent composite planks. Such locking devices can be made of the same material as a composite plank, aluminum, wood fiber, etc.

In still further aspects, the composite plank comprises a decorative layer. In such aspects, the decorative layer is comprises of a cellulose based material and has a top surface and an opposed bottom surface. In still further aspects, the decorative layer overlies the composite core layer such that the top surface of the core layer contacts the bottom surface of the decorative layer.

In still further aspects, the decorative layer of the composite plank can comprise a printed film layer. In yet other aspects, the decorative layer comprises a wear layer. In still further aspects, the decorative layer comprise a printed film layer and a wear layer.

In some aspects, the layers present in the disclosed composite plank are adhered to each other in the absence of a separate adhesive composition. In some exemplary aspects, the decorative layer is adhered to the core layer in the absence of a separate adhesive composition. In still further aspects, when the printed layer and the wear layer are present in the decorative layer, these two layers are adhered to each other in the absence of a separate adhesive composition.

In still further aspects, the dimensions of the composite plank described herein can be easily adjusted depending on the desired applications. Thus, the composite plank can have any desired length, width, and thickness, and in any desired combination thereof. In exemplary non limiting aspects, the disclosed composite plank can have a thickness from about 3 mm to about 10 mm, including exemplary values of about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, and about 9.5 mm. It is understood that the composite plank can have any thickness value between two foregoing values. In certain aspects, the thickness of the composite plank is from 4 mm to 8 mm or from 3.5 mm to 9.5 mm.

In yet other aspects, the composite planks are recyclable. In yet other aspects, the composite planks are substantially recyclable. In still further aspects, the composite planks are 100 % recyclable.

### 1. Core Layer

As disclosed herein, the composite plank comprises a core having a top surface and an opposed bottom surface and a plurality of side edges extending between the opposed top and bottom surfaces. In certain aspects, the core of the disclosed composite plank is comprised of a filled polymeric composition comprising a thermoplastic cellulose ester component and a filler component.

In certain aspects, the thermoplastic cellulose ester component can be obtained through esterification of cellulose. It is understood that in some aspects, introducing ester substituents containing both bulky moieties and soft segments can improve the mobility of the cellulose chain and its processability. In certain aspects, the thermoplastic cellulose ester component has an ester bond with a carboxylic ester. In such exemplary aspects, the thermoplastic cellulose esters component comprises cellulose acetate, cellulose acetate, cellulose propionate, cellulose acetate propionate, or butylate cellulose acetate phthalate, or a combination thereof. In yet other aspects, the thermoplastic cellulose esters component has an ester bond with an oxycarboxylic acid such as lactic acid, glycolic acid, hydroxybutyric acid or its polymer, a cyclic ester such as caprolactone, propiolactone, valerolactone, pivalolactone, or the like, or its polymer, or a mixed ester of these esters. In still further aspects, the thermoplastic cellulose ester component can comprise cellulose acetate propionate. In still further aspects, the thermoplastic cellulose ester component consists essentially of cellulose acetate propionate. It is understood, however, that the present disclosure is not restricted to commercially available materials but further synthetic esters can be used.

In certain aspects, the degree of cellulose substitution in the cellulose ester is from about 0.5 to about 3.0 per glucose unit, including exemplary values of about 0.8, about 1.0, about 1.2, about 1.5, about 1.8, about 2.0, about 2.2, about 2.5, and about 2.8 per glucose unit. It is understood that chemical and physical properties, i.e. fluidity, processability, biodegradability, and the like, of the thermoplastic cellulose esters component can be dependent on the degree of the cellulose substitution. In certain aspects, the thermoplastic cellulose esters component having a specific degree of cellulose substitution can be chosen depending on the desired applications.

In still further aspects, the thermoplastic cellulose ester component can be present in an amount of from about 10 weight percent to about 60 weight percent of the filled polymeric composition, including exemplary values of about 15 weight percent, about 20 weight percent, about 25 weight percent, about 30 weight percent, about 35 weight percent, about 40 weight percent, about 45 weight percent, about 50 weight percent, and about 55 weight percent.

In still further aspects, the thermoplastic cellulose ester component can be added to the filled polymeric composition in an amount of from about 70 to about 130 phr, including exemplary values of about 75 phr, about 80 phr, about 90 phr, about 95 phr, about 100 phr, about 105 phr, about 110 phr, about 115 phr, about 120 phr, about 125 phr.

In a further aspect, the filled polymeric composition comprises a filler. As would be recognized by one of ordinary skill in the art, the type of filler used can be selected on the basis of the desired physical properties of the final product. In a still further aspect, exemplary fillers can include, for example and without limitation, calcium carbonate, barium sulfate, barite, perlite, glass fiber and powder, metal powder, alumina, hydrated alumina, clay, magnesium carbonate, calcium sulfate, silica or glass, fumed silica, talc, carbon black or graphite, fly ash, cement dust, feldspar, nepheline, magnesium oxide, zinc oxide, aluminum silicate, calcium silicate, titanium dioxide, titanates, wood flour, glass microspheres, chalk, and mixtures thereof. In a yet further aspect, additional fillers that can be used include graphite fiber, silica/glass, wollastonite, crushed glass cullet, kaolin, mica, recycled fines, fiberglass, diatomaceous earth, lime, and mixtures thereof. In an even further aspect, an exemplary filler is fly ash, such as, for example and without limitation, Celceram™ fly ash filler PV20A (a calcium aluminum silicate available from Boral). In a further aspect, the filler can comprise post-industrial carpet and/or post-consumer carpet material. In a still further aspect, the filler can comprise composites of post-industrial carpet and/or composites of post-consumer carpet. In some aspects, the glass filler is glass fines or crushed glass cullet. In other aspects, the fly ash is coal fly ash. In yet further aspects the filler component comprises calcium carbonate, perlite, or a combination thereof.

In a further aspect, the filled polymeric composition can comprise the filler component in an amount of from about 20% weight percent to about 95% weight percent of the filled polymeric composition, including exemplary values of about 30 weight percent, about 40 weight percent, about 50 weight percent, about 60 weight percent, about 70 weight percent, about 80 weight percent, and about 85 weight percent. In still further aspects, the filler component can be present in an amount in a range derived from any two of the above listed exemplary weight percentage values. For example, the filled polymer composition can comprise a filler component in a range of from about 30 weight percent to about 80 weight percent, or from about 40 weight percent to about 85 weight percent.

In yet other aspects, the filler component can be added in an amount from about 30 phr to about 250 phr, including exemplary values of about 40 phr, about 50 phr, about 60 phr, about 70 phr, about 80 phr, about 90 phr, about 100 phr, about 120 phr, about 150 phr, about 170 phr, about 200 phr, and about 220 phr.

In still further aspects, the filled polymeric composition present in the core layer can comprise various additives. In certain aspects, the filled polymeric composition comprises plasticizers. The plasticizers present in the filled polymeric composition can comprise a relatively low-molecular weight plasticizer (less than 1000 g/mol) or a relatively high molecular weight plasticizer. In certain exemplary aspects, the relatively low-molecular weight plasticizers can include phthalic acid esters such as dimethyl phthalate, diethyl phthalate, dihexyl phthalate, dioctyl phthalate, dimethoxyethyl phthalate, ethylphthalylethyl glycolate, butylphthalylbutyl glycolate, and the like; aromatic polyvalent carboxylic acid esters such as tetraoctyl pyromellitate, trioctyl trimellitate, and the like; aliphatic polyvalent carboxylic acid esters such as dibutyl adipate, dioctyl adipate, dibutyl sebacate, dioctyl sebacate, diethyl azelate, dibutyl azelate, dioctyl azelate, and the like; polyhydric alcohol lower fatty acid esters such as glycerin triacetate, diglycerin tetraacetate, and the like; phosphate esters such as triethyl phosphate, tributyl phosphate, tributoxyethyl phosphate, tricresyl phosphate, and the like.

In certain exemplary aspects, the relatively high-molecular weight plasticizers include aliphatic polyesters composed of glycol and dibasic acids, such as polyethylene adipate, polybutylene adipate, polyethylene succinate, polybutylene succinate, and the like; aliphatic polyesters composed of oxycarboxylic acids, such as polylactic acid, polyglycolic acid, and the like; aliphatic polyesters composed of lactones, such as polycaprolactone, polypropiolactone, polyvalerolactone, and the like; vinyl polymers such as polyvinylpyrrolidone, and the like.

In yet other exemplary aspects, the composition can comprise a plasticizer having a reactive functional group that include aromatic epoxy compounds such as monofunctional epoxy compounds such as phenyl glycidyl ether, polyglycidyl ethers of polyhydric phenol having at least one aromatic ring or its alkylene oxide addition product, for example, glycidyl ethers produced by reaction of epichlorohydrin and phisphenol compounds such as bisphenol A, tetrabromo bisphenol A, bisphenol F, bisphenol S, and the like, or alkylene oxide (for example, ethylene oxide, propylene oxide, butylene oxide, or the like) addition products of bisphenol compounds; novolac epoxy resins (for example, phenol novolac epoxy resins, cresol novolac epoxy resins, brominated phenol novolac epoxy resins, and the like); trisphenol methane triglycidyl ether; and the like. Examples of alicyclic epoxy compounds include 4-vinylcyclohexene monoepoxide, norbornene monoepoxide, limonene monoepoxide, 3,4-epoxycyclohexylmethyl-3,4-epoxycyclohexane carboxylate, bis-(3,4epoxycyclohexylmethyl) adipate, 2-(3,4-epoxycyclohexyl-5,5spiro-3,4-epoxy) cyclohexanone-meta-dioxane, bis(2,3epoxycyclopentyl) ether, 2-(3,4-epoxycyclohexyl-5,5-spiro3,4-epoxy) cyclohexanone-metha-dioxane, 2,2-bis[4-(2,3-epoxypropoxy)cyclohexyl] hexafluoropropane, and the like.

In yet further exemplary aspects, the aliphatic epoxy compounds include epoxidized soybean fat and oil compounds such as epoxidized soybean oil (ESO), epoxidized linseed oil, and the like; epoxidized fatty acid esters such as epoxidized butyl stearate, and the like. Other examples include 1,4-butanediol diglycidyl ether, 1,6-hexane diol diglycidyl ether, ethylene glycol diglycidyl ether, ethylene glycol monoglycidyl ether, propylene glycol diglycidyl ether, propylene glycol monoglycidyl ether, polyethylene glycol diglycidyl ether, propylene glycol diglycidyl ether, neopentyl glycol diglycidyl ether, neopentyl glycol monoglycidyl ether, glycerol diglycidyl ether, glycerol triglycidyl ether, trimethylolpropane diglycidyl ether, trimethylolpropane monoglycidyl ether, trimethylolpropane triglycidyl ether, diglycerol triglycidyl ether, sorbitol tetraglycidyl ether, allyl glycidyl ether, 2-ethylhexyl glycidyl ether, and the like. It is understood that any of the mentioned above plasticizers can be present in any possible combination.

In certain aspects, the plasticizer can be present in any amount from greater than 0 weight percent to about 20 weight percent based on the filled polymeric composition, including exemplary values of about 0.01 weight percent, about 0.05 weight percent, about 0.08 weight percent, about 0.1 weight percent, about 0.5 weight percent, about 0.8 weight percent, about 1 weight percent, about 1.2 weight percent, about 1.5 weight percent, about 1.8 weight percent, about 2.0 weight percent, about 2.5 weight percent, about 3.0 weight percent, about 3.5 weight percent, about 4.0 weight percent, about 4.5 weight percent, about 5.0 weight percent, about 5.5 weight percent, about 6.0 weight percent, about 6.5 weight percent, about 7 weight percent, about 7.5 weight percent, about 8 weight percent, about 8.5 weight percent, about 9 weight percent, about 9.5 weight percent, about 10 weight percent, about 11 weight percent, about 12 weight percent, about 13 weight percent, about 14 weight percent, about 15 weight percent, about 16 weight percent, about 17 weight percent, about 18 weight percent, and about 19 weight percent.

In still further aspects, the plasticizer can be present in any amount from about 10 phr to about 20 phr, including exemplary values about 11 phr, 12 phr, about 13 phr, about 14 phr, about 15 phr, about 16 phr, about 17 phr, about 18 phr, and about 19 phr. In still further aspects, the plasticizer can be present in an amount in any range derived from the above values. An exemplary plasticizer that can be used is a dioctyl adipate (DOA) plasticizer.

In still further aspects, the filled polymer composition can comprise various lubricants. It is understood that any applicable lubricants can be used. In certain aspect, the lubricant can comprise an ester wax, an amide wax, an oxidized polyethylene polymers, or a combination thereof. In certain aspects, the filler polymer composition comprises an oxidize polyethylene wax (OPE wax). In certain aspects, the lubricant can be present in any amount from greater than 0 weight percent to about 5 weight percent based on the filled polymeric composition, including exemplary values of about 0.01 weight percent, about 0.05 weight percent, about 0.08 weight percent, about 0.1 weight percent, about 0.5 weight percent, about 0.8 weight percent, about 1 weight percent, about 1.2 weight percent, about 1.5 weight percent, about 1.8 weight percent, about 2.0 weight percent, about 2.5 weight percent, about 3.0 weight percent, about 3.5 weight percent, about 4.0 weight percent, and about 4.5 weight percent.

In still further aspects, the lubricant can be present in any amount from about 0.1 phr to about 10 phr, including exemplary values about 0.5 phr, about 0.8 phr, about 1.0 phr, about 1.5 phr, about 2 phr, about 2.5 phr, about 3 phr, about 4 phr, about 5 phr, about 6 phr, about 7 phr, about 8 phr, and about 9 phr.

In yet other aspects, the filled polymeric composition consists essentially of the thermoplastic cellulose ester component and the filler component.

In still further aspects, the core layer can further comprise up to about 10% chemical additives such as anti-UV agents, anti-oxidation agents, stabilizers, colorants, anti-fungus agents, coupling agents, reinforcing agents, processing aids, and lubricants.

In a further aspect, the core layer of the present invention can optionally comprise one or more additives, for example and without limitation, tackifiers, processing agents, foaming agents, hydrocarbon resins, plasticizers, or the like.

In a further aspect, the core layer can have an exemplary and non-limiting density from about 1.1 g/cm³ to about 1.5 g/cm³.

In yet other aspects, the core layer has a thickness from about 3 mm to about 10 mm, including exemplary values of about 3.5 mm, about 4 mm, about 4.5 mm, about 5 mm, about 5.5 mm, about 6 mm, about 6.5 mm, about 7 mm, about 7.5 mm, about 8 mm, about 8.5 mm, about 9 mm, and about 9.5 mm. It is understood that the core layer can have any thickness value between two foregoing values. In certain aspects, the thickness of the composite plank is from 4 mm to 8 mm or from 3.5 mm to 9.5 mm.

### 2. Decorative Layer

According to aspects of the invention, the composite plank comprises a decorative layer. In certain aspects, the decorative layer has a top surface and an opposed bottom surface. In yet other aspects, the decorative layer overlies the composite core layer such that the top surface of the core layer contacts the bottom surface of the decorative layer.

In still further aspects, the decorative layer comprises a printed film layer. In still further aspects, the decorative layer comprises a wear layer. In yet other aspects, the decorative layer comprises a printed film layer and a wear layer. In yet other aspects, the printed film layer and the wear layer each comprise a cellulose based material.

In certain aspects, the printed film layer comprises a substrate and an ink layer. In still further aspects, the ink layer has a top surface and an opposed bottom surface. In still further aspects, at least a layer of the top surface of the ink layer defines at least a portion of the top surface of the decorative layer. Optionally, the ink layer can also define the bottom surface of the decorative layer.

In certain aspects, the substrate layer of the printed film layer has a top surface and an opposed bottom surface. In still further aspects, the ink layer can be applied to the top surface of the substrate layer. Optionally, the ink layer can be applied to the bottom surface of the substrate layer. In certain aspects, the bottom surface of the substrate layer can define the bottom surface of the decorative layer overlying the top surface of the core layer. Yet in other aspects, the top surface of the substrate layer can define the bottom surface of the decorative layer overlying the top surface of the core layer.

In certain aspects, it is contemplated that the ink layer can be applied either directly or indirectly to the top surface of the substrate layer. In a further aspect, the ink layer can comprise any conventional ink, dye, pigment, or other marking substance that can be applied within the composite plank in a desired pattern. For example and without limitation, the ink layer can comprise water-based, soy-based, a UV-cured inks, and/or solvent-based pigments. In still further aspect, the ink layer is a UV cured ink.

It is understood that UV-cured inks can comprise photo-initiators, pigments, additives, monomers and oligomers of various polymers, and the like. In some exemplary aspects, the UV-cured inks can comprise, without limitation, (5-ethyl-1,3-dioxan-5yl)methyl acrylate, 2-phenoxyethyl acrylate; 1-vinylhexahydro-2H-azepin-2-one, substituted phosphine oxide, thrimethylolpropane triacrylate, phenyl bis (2,4 6-trimethylbenzoyl)phosphine oxide, epoxy acrylate oligomer, diacrylate monomer, multi-functional monomers, amine modified acrylate oligomer, 1-vinylhexahydro-2H-asepin-2-one, diacrylate oligomers, benzophenone, triacryalte monomers, 1-hydroxy-cyclohexylphenyl-ketone, 2hydroxy-2-methylpropiophenone, and the like.

In a further aspect, the ink layer can be applied to the substrate layer by any conventional printing means, which can include, without limitation, rotogravure printing, flexography printing, lithography printing, offset-lithography printing, relief printing, thermography printing, thermal sublimation printing, dye-sublimation printing, heat-transfer printing, digital printing, and the like.

In still further aspects, the ink layer applied by a digital printing. In an exemplary aspect, the ink layer can comprise inks and pigments manufactured by Collins Inks, INX Inks, Durst, HP, EFI, Sun Chemical, or Tiger. In yet other aspects, the ink layer can be digitally printed utilizing digital printers manufactured by Cefla, Durst, Hymmen, EFI, Barbaran or Inca.

In certain aspects, the formed ink layer can be a continuous layer that covers substantially the entire top surface of the substrate. In yet other aspects, the formed ink layer can be a discontinuous layer that covers only a portion of the top surface of the substrate. In yet other aspects, the ink layer can have any desired aesthetic appearance, such as, for example and without limitation, the appearance of simulated hardwood or ceramic flooring.

In certain aspects, the substrate layer can comprise a cellulose based material. In still further aspects, the substrate layer can comprise any thermoplastic cellulose esters described herein. In still further aspects, the substrate layer can comprise cellulose acetate, cellulose acetate propionate, cellulose propionate, cellulose butyrate, or any combination thereof.

In some aspects, the substrate layer is whitened or opaque. In yet other aspects, the substrate layer can comprise any whitening agent known in the art. It is further understood that the whitening agent disclosed herein can comprise inorganic and/or organic compounds. In yet other aspects, the whitening agent can be a fluorescent whitening agent. In some exemplary aspects, the whitening chemistry comprises titanium dioxide, zinc dioxide, and the like. In some other aspects, the whitening can be also achieved by cavitation.

In certain aspects, the substrate layer has a thickness from about 1 mil to about 20 mil, including exemplary values of about 2 mil, about 3 mil, about 4 mil, about 5 mil, about 6 mil, about 7 mil, about 8 mil, about 9 mil, about 10 mil, about 11 mil, about 12 mil, about 13 mil, about 14 mil, about 15 mil, about 16 mil, about 17 mil, about 18 mil, and about 19 mil. In still further aspects, the substrate layer can have any thickness in a range derived from any two of the above listed exemplary values. For example, the substrate layer can comprise a thickness in a range of from about 1 mil to about 5 mil, or from about 3 mil to about 7 mil. In still further aspects, the substrate layer can be a film.

### 3. Wear Layer

According to various aspects of the invention, the decorative layer of the disclosed composite plank comprises a wear layer. In certain aspects, the wear layer has a top surface and an opposed bottom surface. In still further aspects, the wear layer substantially overlies the printed film layer such that at least a portion of the bottom surface of the wear layer contacts the top surface of the printed film.

In certain aspects, the top surface of the wear layer can be configured for exposure to an ambient environment. In still further aspects, the wear layer can comprise a cellulose based material. In still further aspects, the wear layer can comprise any thermoplastic cellulose esters described herein. In still further aspects, the wear layer can comprise cellulose acetate, cellulose acetate propionate, cellulose propionate, cellulose butyrate, or any combination thereof.

In some aspects, the wear layer is substantially transparent. In other aspects, the wear layer is substantially opaque.

In a yet further aspect, the wear layer can have a thickness in the range of from about 4 mil to about 30 mil, including exemplary thickness ranges of from about 4 to about 8 mil, about 9 to about 14 mil, or about 16 to about 30 mil. In a still further aspect, the thickness can be in a range derived from any of the above listed exemplary values. For example, the thickness can in the range of about 4 mil to about 9 mil, or from 4 mil to about 16 mil. In another aspect, the wear layer can be embossed with a desired texture pattern.

In still further aspects, the wear layer is adhered to the printed film layer in the absence of any adhesives. In still further aspects, the wear layer is adhered to the printed layer by lamination. In still further aspects, the wear layer is adhered to the printed layer by the means of applying heat and pressure.

In various aspects, the top surface of the wear layer can further comprise a scratch layer. In one aspect, the scratch layer can comprise polyurethane, or acrylate, or a combination thereof. In a further aspect, the scratch layer can comprise a mixture of reactive monomers and oligomers. In a still further aspect, the scratch layer can comprise functionalized monomers, for example, and without limitation, difunctional and multifunctional monomers. In an even further aspect, the scratch layer can comprise at least one photoinitiator, or other component to catalyze a reaction among materials present in the scratch layer. In some aspects, the scratch layer comprises a blend of epoxy acrylate oligomers with difunctional and multifunctional monomers. In still further aspects, the scratch layer is a UV-cured scratch layer.

In a further aspect, the scratch layer comprises a surface hardening agent. In a still further aspect, the surface hardening agent can comprises aluminate, alumina, acrylic beads, silica, glass spheres, sol gel alumina, nylon Orgasol, MF silica Optbeads, polyethylene dispersion, silyl acrylic set wet particles, wollastonite, clay, silyl acrylic polysiloxane, sodium silicate, polyvinylidene difluoride (PVDF), silicon carbide, quartz, diamond dust, or a combination thereof. In some aspects, the surface hardening agent is alumina, silica, or a combination thereof.

In a further aspect, the scratch layer has a thickness in the range of from about 0.25 to about 3 mils, including exemplary ranges of from about 0.50 to about 1.25 mils, and 0.50 to about 2.25 mils. In a still further aspect, the surface hardening agent is present in an amount in the range of from about 0.25 weight % to about 15 weight % based upon the total weight of the scratch layer, including exemplary ranges of from about 2 weight % to about 3 weight %, and about 2 weight % to about 10 weight % based upon the total weight of the scratch layer. In some aspects, the surface hardening agent is present in an amount less than or equal to 10 weight %, for example, less than about 9, 8, 7, 6, 5, 4, 3, 2, or 1 weight % based upon the total weight of the scratch layer. In a further aspect, the surface hardening agent comprises particulate material having an average particle size less than or equal to 20 microns, for example, less than or equal to about 15, 10, 9, 8, 7, 6, 5, 4, 3, 2, or 1 micron. In some aspects, the scratch layer is adhered to an underlying wear layer by a primer coating layer. In a further aspect, the primer coating layer has a thickness in the range of from about 0.25 to about 1 mil, for example, from about 0.40 to about 0.6 mil.

In still further aspects, the decorative layer is adhered to the core layer in the absence of any adhesives. In still further aspects, the decorative layer is adhered to the core layer by lamination. In still further aspects, the decorative layer is adhered to the core layer by means of applying heat and pressure.

### 4. Properties of Resilient Floor Coverings

According to various aspects of the disclosure, the composite plank of the present invention exhibit improved physical and mechanical properties.

In one aspect, the composite plank exhibits a maximum flexural load according to ASTM-D 790 standard of at least 12.5 pounds per foot, including exemplary values of at least 13 pounds per foot, at least 13.5 pounds per foot, at least 14 pounds per foot, at least 14.5 pounds per foot, or at least 15 pounds per foot. In still further aspects, the plank can exhibit a maximum flexural load of even at least 20 pounds per foot.

In some aspects, the wear layer can exhibit a pull value greater than about 3 pounds, greater than about 3.5 pounds, greater than about 4 pounds, greater than about 4.5 pounds, greater than about 5 pounds, greater than about 5.5 pounds, greater than about 6 pounds, greater than about 6.5 pounds, or greater than about 7 pounds as determined by ASTM 3936 with 1″ by 6″ strip pulled at a rate of 2″ min for a pull distance of 2″.

In some aspects, the wear layer can exhibit an abrasion resistance greater than 5,000 cycles when measured according to ASTM D3884 under testing conditions comprising an H18 wheel, 1,000 gram load, and clean each 300 cycles, including exemplary abrasion resistances of greater than 5,000 cycles, greater than 10,000 cycles, or greater than 20,000 cycles when measured according to ASTM D3884 under testing conditions comprising an H18 wheel, 1,000 gram load, and clean each 300 cycles.

In some aspects, the scratch layer in combination with the wear layer exhibits an abrasion resistance greater than 5,000 cycles when measured according to ASTM D3884 under testing conditions comprising an H18 wheel, 1,000 gram load, and clean each 300 cycles, including exemplary abrasion resistances of greater than 5,000 cycles, greater than 10,000 cycles, or greater than 20,000 cycles when measured according to ASTM D3884 under testing conditions comprising an H18 wheel, 1,000 gram load, and clean each 300 cycles.

In some aspects, the scratch layer exhibits an abrasion resistance in the range of from about 100 cycles to about 500 cycles when measured according to ASTM D3884 under testing conditions comprising an H18 wheel, 1,000 gram load, and clean each 300 cycles, including exemplary abrasion resistances ranges of from about 100 cycles to about 400 cycles, or from about 200 cycles to about 300 cycles when measured according to ASTM D3884 under testing conditions comprising an H18 wheel, 1,000 gram load, and clean each 300 cycles.

In some aspects, the disclosed composite planks exhibit a dimensional stability variation of less than about 0.17% as determined by ASTM F2199-0 at 82° C. and 24 hr., including dimensional stability values of less than about 0.15% or less than about 0.10% as determined by ASTM F2199-0 at 82° C. and 24 hr.

### B. Methods of Making

In various aspects, the present disclosure also provides methods of making the composite planks described herein. In one aspect, a method of making the composite planks described herein comprises a) forming a core layer from a composition comprising a thermoplastic cellulose ester component and a filler component; wherein the formed core layer has a top surface and an opposed bottom surface and a plurality of side edges extending between the opposed top and bottom surfaces, and b) applying a decorative layer comprised of a cellulose based material to the top surface of the core layer.

It is understood that any described above thermoplastic cellulose esters can be utilized. It is still further understood that any described fillers can be utilized.

In still further aspects, the thermoplastic cellulose ester component can be present in an amount of from about 10 weight percent to about 60 weight percent of the filled polymeric composition, including exemplary values of about 15 weight percent, about 20 weight percent, about 25 weight percent, about 30 weight percent, about 35 weight percent, about 40 weight percent, about 45 weight percent, about 50 weight percent, and about 55 weight percent.

In still further aspects, the thermoplastic cellulose ester component can be added to the filled polymeric composition in an amount of from about 70 to about 130 phr, including exemplary values of about 75 phr, about 80 phr, about 90 phr, about 95 phr, about 100 phr, about 105 phr, about 110 phr, about 115 phr, about 120 phr, about 125 phr.

In a further aspect, the filler component can be present in an amount of from about 20% weight percent to about 95% weight percent of the filled polymeric composition, including exemplary values of about 30 weight percent, about 40 weight percent, about 50 weight percent, about 60 weight percent, about 70 weight percent, about 80 weight percent, and about 85 weight percent. In still further aspects, the filler component can be present in an amount in a range derived from any two of the above listed exemplary weight percentage values. For example, the filled polymer composition can comprise a filler component in a range of from about 30 weight percent to about 80 weight percent, or from about 40 weight percent to about 85 weight percent.

In yet other aspects, the filler component can be added in an amount from about 50 phr to about 200 phr, including exemplary values of about 60 phr, about 70 phr, about 80 phr, about 90 phr, about 100 phr, about 120 phr, about 150 phr, about 170 phr, and about 190 phr.

In still further aspects, the thermoplastic cellulose ester component comprises cellulose acetate propionate. In yet other aspects, the filler component comprises calcium carbonate, perlite, or a combination thereof. In still further aspects, the filled polymer composition consists essentially of the thermoplastic cellulose ester component and the filler component. In yet other aspects, the thermoplastic cellulose ester component consists essentially of cellulose acetate propionate.

In certain aspects, the core layer is formed by subjecting the composition comprising a thermoplastic cellulose ester component and a filler component to heat and pressure. In certain aspects, the core is formed by subjecting the composition to a temperature at a range from about 100° C. to about 300° C., including exemplary values of about 110° C., about 120° C., about 130° C., about 140° C., about 150° C., about 160° C., about 170° C., about 180° C., about 190° C., about 200° C., about 210° C., about 220° C., about 230° C., about 240° C., about 250° C., about 260° C., about 270° C., about 280° C., and about 290° C.

In yet other aspects, the core is formed by subjecting the composition to a pressure at a range from about 10 psi to about 3,000 psi, including exemplary values of about 20 psi, about 30 psi, about 50 psi, about 100 psi, about 200 psi, about 400 psi, about 500 psi, about 700 psi, about 1,000 psi, about 1,200 psi, about 1,500 psi, about 1,700 psi, about 2,000 psi, about 2,200 psi, about 2,500 psi, and about 2,700 psi.

In yet further aspects, the core is formed by subjecting the composition to a temperature at a range from about 100° C. to about 300° C., and a pressure of 10 psi to about 3,000 psi.

In still further aspects, the composition comprising any of described above thermoplastic cellulose ester components and filler components is formed into a core layer by subjecting the composition to heat and pressure.

In still further aspects, any methods known in the art can be utilized to subject the composition to heat and pressure. In certain aspects, a double belted press is used to subject the composition to heat and pressure. The use of a double-belt process allows for improved control of the pressure and temperature conditions to obtain the desired composite. The double-belt process allows for consolidation of the composition components to form the core of the composite plank by applying a pressure to the components between the conveyer belts while applying heat to set the components to a desired composite product.

The exemplary process for making the core layer is shown in FIG. 2. The components 202 and 204 are fed into the double-belt press 200. The two components are pressed together with an optional contact pressure nip roller 206 at inlet, and then pass through a heating zone 208. Then the composition passes through at least one pair of additional nip rollers 210 (FIG. 2 depicts use of the two pairs of nip rollers 210 and 212) that applies a desired pressure to the composition to obtain a core layer of a desired thickness. The composition then can pass through an additional optional heating zone 208a. The pressure nip rollers can be heated or cooled depending on the desired operation. The composite material is then passes through a cooling zone 214 to provide a final product 216.

In still further aspects, the decorative layer can be applied on the surface of the core layer by a lamination process. In still further aspects, such a lamination processes can also involve a double belted press. In yet other aspects, the lamination process does not comprises the application of any adhesive materials. In yet other aspects, the composite plank is formed without the use of adhesives. However, if desired, it should be understood that an adhesive material can be used.

The decorative layer can comprise any components described above. In certain aspects, the decorative layer comprises a printed film. In yet other aspects, the decorative layer comprises a wear layer. In still further aspects, the decorative layer comprises a printed film and a wear layer.

In yet other aspects, the printed film comprises a substrate and an ink layer. In still further aspects, the method comprises printing a digital image on a substrate layer to form the ink layer. In a yet further aspect, the method described herein can comprise applying the wear layer thereto the printed film. In some aspects, the top surface of the wear layer can be exposed to an ambient environment. In a further aspect, the described methods can further comprise applying a scratch layer to the top surface of the wear layer.

It is understood that digitally printed inks that can be used to form an ink layer can comprise any UV-curable inks known in the art and described herein. It is further understood that after digitally printing the image onto the substrate, the inks are UV-cured. In some aspects, the curing process comprises one step. This type of curing process is known in the industry as an A-stage curing. In yet other aspects the curing process comprises a number of steps. In certain aspects, the curing process can comprise a first step and a second step. This type of curing process is known in the industry as a B-stage curing. In some aspects, the first step of the curing process is applied to the ink layer printed on the substrate at a curing energy lower that a curing energy usually utilized in A-stage curing processes. In still further aspects, the energy used in the first step of the B-stage curing process can be about ½ of the energy used in the A-stage curing process. In certain aspects, the first step of the B-stage curing process can produce a partially cured ink layer. In other aspects, the tie layer can be applied to this partially cured ink layer, and then a second step of the B-stage curing process is performed. In still further aspects, the tie layer can be applied to the partially cured ink layer followed by application of the wear layer, and only then is the second step of the B-stage curing process performed.

In various aspects, the disclosed layers of the composite planks can be constructed or otherwise formed by conventional methods and/or processes. Similarly, it is contemplated that the respective layers can be connected to each other in sequential or non-sequential order. Unless otherwise stated, no particular order of operative steps for product formation is required to practice the present invention. Finally, it is contemplated that after the layers of the composite plank are joined together, the resulting plank can be cut into desired shapes and desired sizes, for example, planks or tile shapes that can be conventionally or non-conventionally sized and/or shaped.

As disclosed herein, in one aspect, the materials that are selected for the respective layers of the composite plank can be readily recycled.

In a further aspect, the edge profile can have any desired edge profile design, for example and without limitation, a click-lock or tongue and groove connection system. In some aspects, the edge profile for connecting can have a more complex geometry. In a further aspect, the edge connection system can substantially restrict movement from side-to-side and vertically. In a still further aspect, the connection seams, once installed, are all uniform and flat at each connection point. In a yet further aspect, the edge profile can be different for all four edges.

In a further aspect, the edge profile can be formed by any desired means, for example, by milling, routing, or a tenoner process, or the like.

In various aspects, the composite planks of the present invention advantageously do not exhibit flaking, melting, or delamination during the edge profiling process. In a further aspect, the disclosed composite planks do not exhibit brittle or weak edge connection profiles.

Although several embodiments of the invention have been disclosed in the foregoing specification, it is understood by those skilled in the art that many modifications and other embodiments of the invention will come to mind to which the invention pertains, having the benefit of the teaching presented in the foregoing description and associated drawings. It is thus understood that the invention is not limited to the specific embodiments disclosed hereinabove, and that many modifications and other embodiments are intended to be included within the scope of the appended claims. Moreover, although specific terms are employed herein, as well as in the claims that follow, they are used only in a generic and descriptive sense, and not for the purposes of limiting the described invention, nor the claims that follow.

What is claimed is:

1. A composite plank, comprising:
a homogeneous core layer having a top surface and an opposed bottom surface and a plurality of side edges extending between the opposed top and bottom surfaces,
wherein the homogeneous core layer consists of a filled polymeric composition comprising:
from about 10 weight percent to about 60 weight percent of cellulose acetate propionate, and
from about 30 to 80 weight percent of a filler component; and
a decorative layer comprising a printed film layer and a wear layer comprising cellulose acetate propionate,
wherein the printed film layer comprises a substrate comprising cellulose acetate propionate and an ink layer,
wherein the decorative layer has a top surface and an opposed bottom surface,
wherein the opposed bottom surface of the decorative layer is a bottom surface of the substrate, and
wherein the decorative layer overlies the homogeneous core layer.

2. The composite plank of claim 1, wherein the filled polymeric composition comprises from about 20 weight percent to about 50 weight percent of cellulose acetate propionate, and from about 40 to 70 weight percent of a filler component.

3. The composite plank of claim 1, wherein the filled polymeric composition comprises from about 30 weight percent to about 40 weight percent of cellulose acetate propionate, and from about 50 to 70 weight percent of a filler component.

4. The composite plank of claim 1, wherein the filled polymeric composition comprises at least 90 weight percent of the combination of cellulose acetate propionate and the filler component.

5. The composite plank of claim 1, wherein the filled polymeric composition comprises at least 95 weight percent of the combination of cellulose acetate propionate and the filler component.

6. The composite plank of claim 4, wherein the filled polymeric composition further comprises:
from greater than 0% to 2 % by weight of a lubricant;
from greater than 0% to 5 % by weight of a plasticizer; and
from greater than 0% to 2% by weight of one or more additives selected from the group consisting of an anti-UV agent, an anti-oxidation agent, a stabilizer, a colorant, an anti-fungus agent, a coupling agent, a reinforcing agent, a processing aid, a tackifier, and a foaming agent.

7. The composite plank of claim 5, wherein the filled polymeric composition further comprises:
from greater than 0% to 1 % by weight of a lubricant;
from greater than 0% to 2 % by weight of a plasticizer; and
from greater than 0% to 1% by weight of one or more additives selected from the group consisting of an anti-UV agent, an anti-oxidation agent, a stabilizer, a colorant, an anti-fungus agent, a coupling agent, a reinforcing agent, a processing aid, a tackifier, and a foaming agent.

8. The composite plank of claim 6, wherein the filled polymeric composition consists of cellulose acetate propionate, the filler component, the lubricant, the plasticizer, and the one or more additives.

9. The composite plank of claim 1, wherein the homogeneous core layer is the only core layer in the composite plank.

10. The composite plank of claim 9, wherein the core has a thickness from 3 mm to 8 mm.

11. The composite plank of claim 1, wherein the homogeneous core layer is a single homogenous core layer, wherein the opposed bottom surface of the homogeneous core layer defines an outermost surface of the composite plank and wherein the opposed bottom surface of the homogeneous core layer does not contact an additional layer in the composite plank.

12. The composite plank of claim 1, wherein the top surface of the decorative layer comprises a scratch layer that overlies a top surface of the wear layer.

13. The composite plank of claim 12, wherein the scratch layer is a UV-cured scratch layer.

14. The composite plank of claim 1, wherein the substrate is opaque.

15. The composite plank of claim 1, wherein the substrate has a thickness from 1 mil to 15 mil.

16. The composite plank of claim 1, wherein the filler component comprises calcium carbonate, perlite, or a combination thereof.

17. The composite plank of claim 1, wherein the filler component consists of calcium carbonate and perlite.

18. The composite plank of claim 1, wherein the decorative layer is adhered to the homogeneous core layer in the absence of a separate adhesive composition.

19. The composite plank of claim 1, wherein the composite plank exhibits a maximum flexural load according to ASTM-D790 of at least 12.5 pounds.

20. The composite plank of claim 1, wherein the top surface of the homogeneous core layer directly contacts the bottom surface of the substrate.

21. A composite plank, comprising:
a homogeneous core layer having a top surface and an opposed bottom surface and a plurality of side edges extending between the opposed top and bottom surfaces, wherein the homogeneous core layer has a thickness from 3 mm to 8 mm,
wherein the homogeneous core layer consists of a filled polymeric composition comprising:
cellulose acetate propionate, and
a filler component; and
a decorative layer comprising a printed film layer and a wear layer comprising cellulose acetate propionate,
wherein the printed film layer comprises a substrate comprising cellulose acetate propionate and an ink layer,
wherein the decorative layer has a top surface and an opposed bottom surface,
wherein the opposed bottom surface of the decorative layer is a bottom surface of the substrate,
wherein the decorative layer overlies the homogeneous core layer.

22. The composite plank of claim 21, wherein the homogeneous core layer is the only core layer in the composite plank.

23. The composite plank of claim 21, wherein the filled polymeric composition comprises from about 20 weight percent to about 50 weight percent of cellulose acetate propionate, and from about 40 to 70 weight percent of a filler component.

24. The composite plank of claim 21, wherein the filled polymeric composition comprises from about 30 weight percent to about 40 weight percent of cellulose acetate propionate, and from about 50 to 70 weight percent of a filler component.

25. The composite plank of claim 21, wherein the top surface of the decorative layer comprises a scratch layer that overlies a top surface of the wear layer.

26. The composite plank of claim 25, wherein the scratch layer is a UV-cured scratch layer.

27. The composite plank of claim 23, wherein the filled polymeric composition further comprises:
from greater than 0% to 2 % by weight of a lubricant;
from greater than 0% to 5 % by weight of a plasticizer; and
from greater than 0% to 2% by weight of one or more additives selected from the group consisting of an anti-UV agent, an anti-oxidation agent, a stabilizer, a colorant, an anti-fungus agent, a coupling agent, a reinforcing agent, a processing aid, a tackifier, and a foaming agent.

28. The composite plank of claim 21, wherein the filler component comprises calcium carbonate, perlite, or a combination thereof.

29. The composite plank of claim 21, wherein the filler component consists of calcium carbonate and perlite.

30. The composite plank of claim 21, wherein the top surface of the homogeneous core layer directly contacts the bottom surface of the substrate.
